(19) United States
(12) Patent Application Publication
(10) Pub. No.: US 2006/0186726 A1
(43) Pub. Date: Aug. 24, 2006

(54) Apparatus for maintaining the orientation of a badge or other insignia

(76) Inventor: Shane Cannon, Wybunbury (GB)

Correspondence Address: SALTER & MICHAELSON;THE HERITAGE BUILDING, 321 SOUTH MAIN STREET, PROVIDENCE, RI, 029037128, US

(21) Appl. No.: 10/541,570

(22) PCT Filed: Jan. 8, 2004
(86) PCT No.: PCT/GB04/00030

§ 371 Date: Nov. 30, 2005

(30) Foreign Application Priority Data
Jan. 10, 2003 (GB) 0300553.5

(51) Int. Cl. B60B 7/04

(52) U.S. Cl. 301/37.26

(57) ABSTRACT

Apparatus for maintaining the orientation of a badge 6 comprises a housing (1) which is a snap fit in a vehicle wheel (2). The badge 6 is mounted on a support (7) which comprises an axle (8) mounted on bearings (4) and (5) and a counterweight (9). The counterweight creates an off axis centre of gravity which provides a force to maintain the correct orientation of the badge. Movement is damped to prevent excessive oscillation. Damping may be frictional, fluid, air or magnetic. In a modification a centrifugal clutch may be provided to restrain oscillation. In a further modification the position of the badge may be electronically controlled.

The present invention relates to apparatus for maintaining the orientation of a badge or other insignia on a rotatable member. The apparatus is particularly, but not exclusively, intended for maintaining the orientation of a badge or other insignia in the hub of a vehicle wheel during rotation of the wheel.

Arrangement of this general nature are already known. In one such arrangement described in US 2002/0125762A1 a coupler is provided for connection to a vehicle wheel hub. In one form the coupler includes a threaded stud detachably engageable with the internal threads of a mating threaded bore in the hub. This leads to a complicated and expensive arrangement which is difficult to construct and which may be prone to failure. It is an object of the present invention to mitigate these disadvantages.

According to the present invention there is provided apparatus for maintaining the orientation of a badge or other insignia on a rotatable member comprising a housing adapted for attachment to the rotatable member, bearing means located within the housing, a support mounted in the bearing means and adapted to carry the badge or other insignia and means for urging the support to a datum position with respect to the housing whereby, in operation, the orientation of the support and any badge or other insignia connected to it may be maintained, relative to the housing, as the housing rotates.

In a preferred embodiment of the invention, the housing is moulded from synthetic plastics material and is adapted to be a snap fit in the wheel to which it is, in use, to be connected. For this purpose tabs are provided on the housing. The bearing means advantageously comprises two bearings. The support comprises an axle and the two bearings are axially spaced along the axle. The badge or other insignia are connected to the support, preferably by means of adhesive. The bearings are retained on the axle by means of a retainer. The retainer preferably comprises a star washer advantageously made of spring steel. The means for urging the support comprises a counterweight which advantageously forms an integral part of the support. The counterweight provides a centre of gravity which is radially off axis and is hung in a manner which both avoids applying a bending movement to the bearings and also loads each of the two bearings equally. A lens is positioned closely adjacent the badge and other insignia. It is sealed to the housing. An end cap closes off the housing on the side remote from the lens. The lens and end cap together with the housing form a sealed assembly.

The invention also comprises a vehicle wheel having an assembly as defined above.

In order that the invention may be more clearly understood, one embodiment thereof will now be described by way of example with reference to the accompanying drawings in which:—

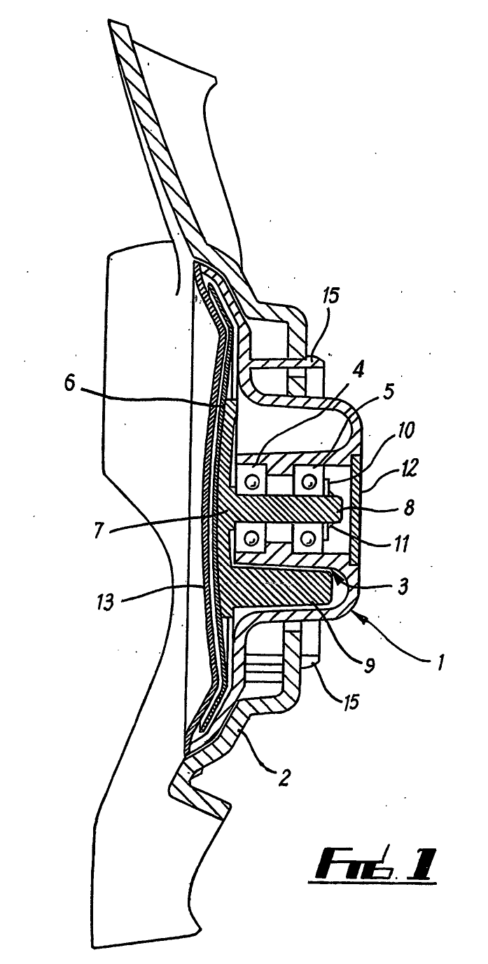

FIG. 1 shows a cross-section through a badge assembly for a vehicle wheel

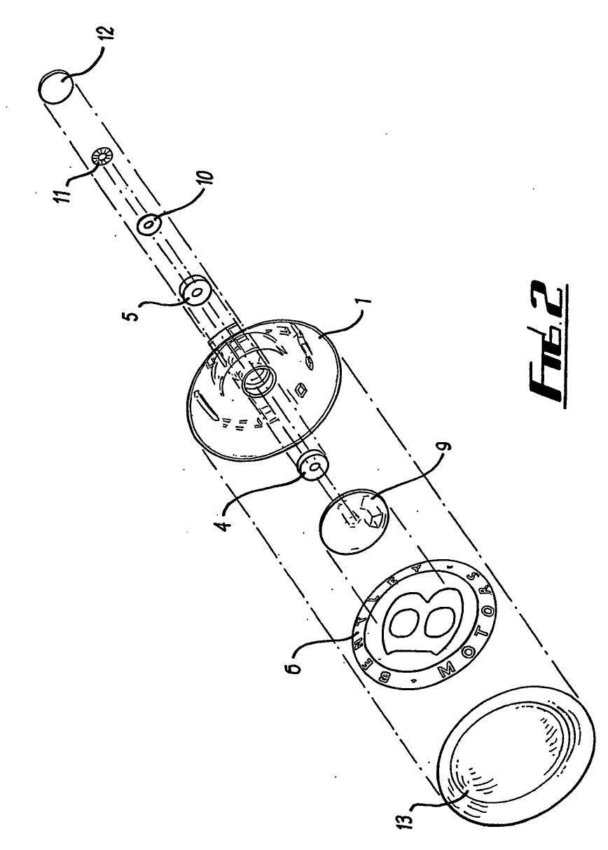

FIG. 2 shows an exploded isometric view of the badge assembly of FIG. 1,

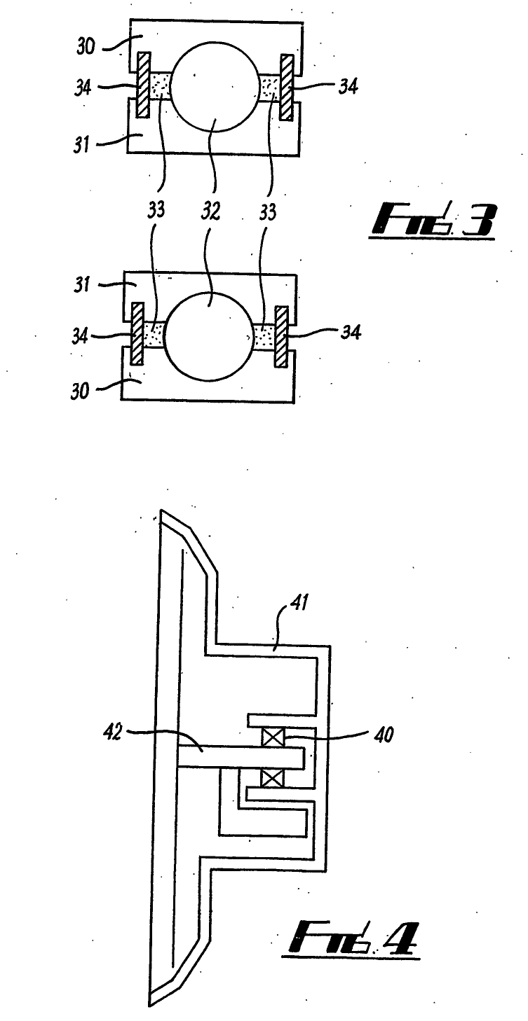

FIG. 3 shows a diagrammatic cross-section of a bearing forming part of the assembly of FIGS. 1 and 2,

FIG. 4 shows a diagrammatic cross-section of a modification of the assembly shown in FIGS. 1 and 2,

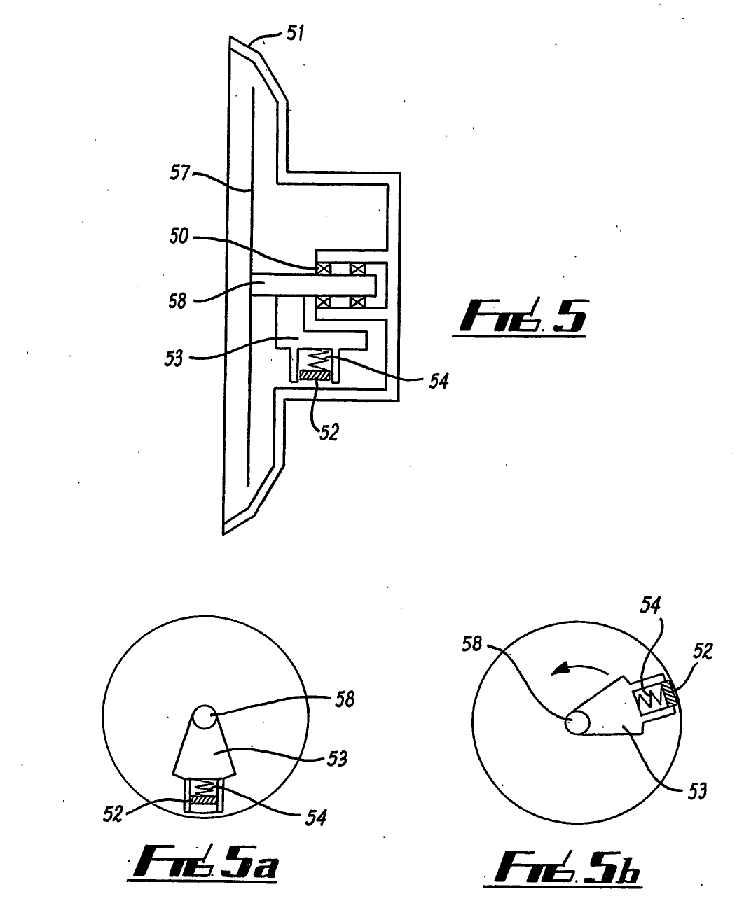

FIG. 5 shows a diagrammatic cross-section of another modification of the assembly shown in FIGS. 1 and 2,

FIGS. 5a and 5b respectively show diagrammatic front elevational views of part of the modification of FIG. 5 for two different operational conditions,

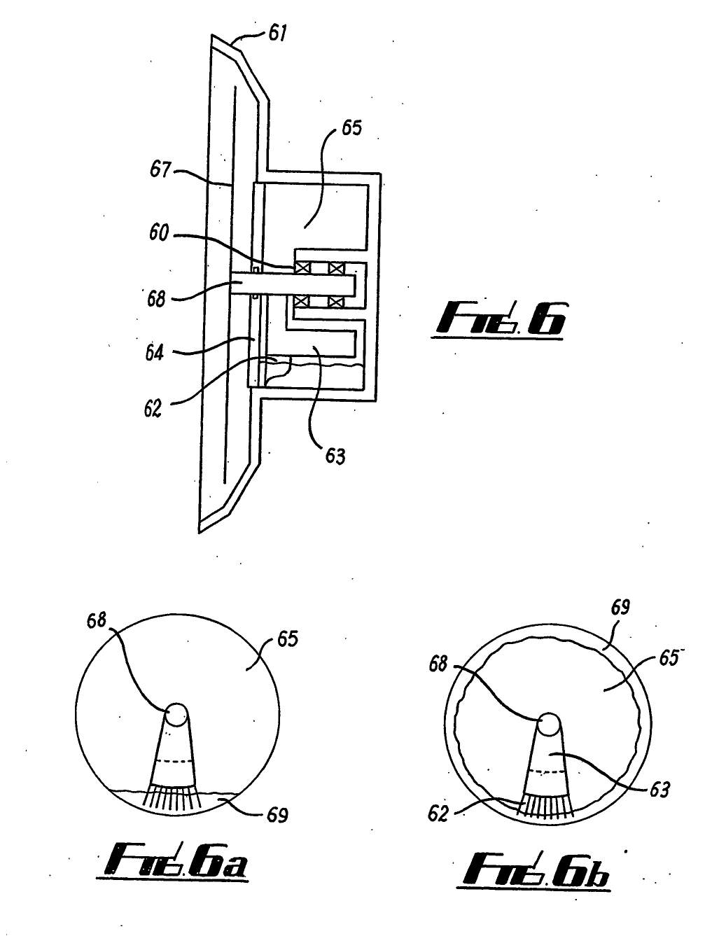

FIG. 6 shows a diagrammatic cross-section of a further modification of the assembly shown in FIGS. 1 and 2,

FIGS. 6a and 6b respectively show diagrammatic front elevational views of part of the modification of FIG. 6 for two different operational conditions,

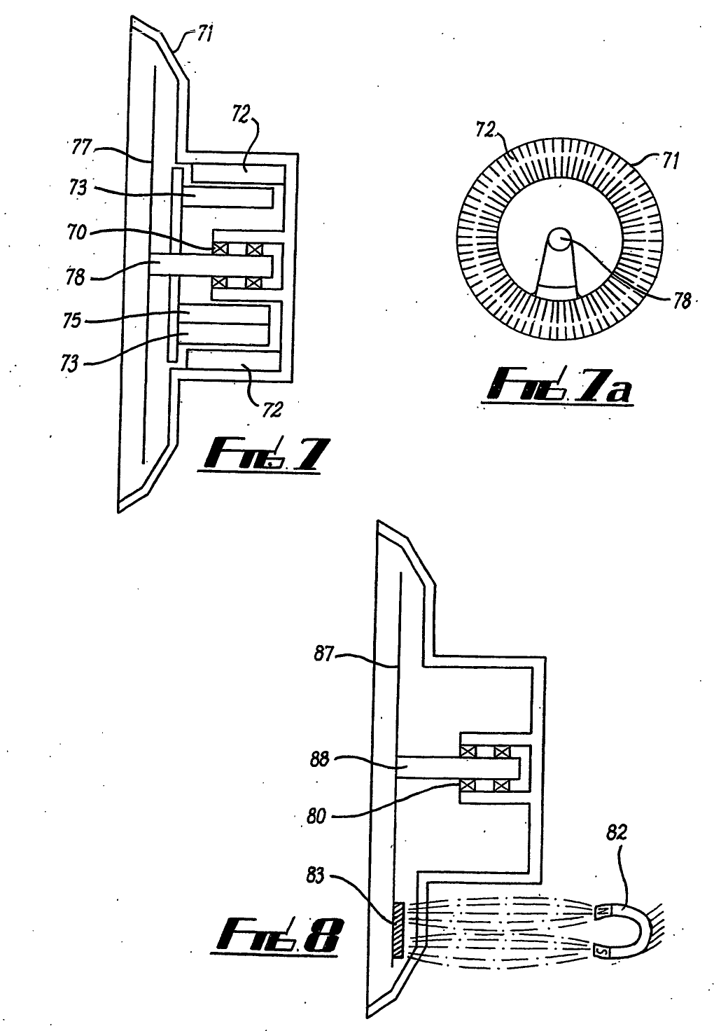

FIG. 7 shows a diagrammatic cross-section of a further modification of the assembly shown in FIGS. 1 and 2,

FIG. 7a diagrammatically shows a front elevational view of part of the modification of FIG. 7 and,

FIG. 8 shows a diagrammatic cross-section of a still further modification of the assembly of FIGS. 1 and 2

Referring to the figures, the assembly comprises a housing 1 which is moulded from a heat resistant synthetic plastics material and is a snap fit in the vehicle wheel 2. Tabs 15 are provided for this purpose on the housing 1. No tools are needed to fix the housing 1 in the vehicle wheel 2. This arrangement and material permits repeated removal and refitting of the assembly without reduction in function. The housing 1 comprises an annular formation 3 which supports two rows of bearings 4 and 5 spaced away from each other and concentrically mounted in the formation 3. The assembly also comprises a badge 6 mounted on a support 7. The support 7 comprises an axle 8 which is mounted in the bearings 4 and 5 and a counterweight 9. The badge 6 is made of an ultra-violet (UV) resistant material. The axle 8 is retained within the two rows of bearings 4 and 5 and the bearings 4 and 5 within the housing 1 by means of a concentrically mounted steel washer 10 and a steel star washer 11. The washer 10 provides a suitable bearing surface for washer 11. On the inner side of the wheel 2 the housing 1 closed off by means of an end cap 12 moulded from the synthetic plastic material.

The badge 6, which is made of ultraviolet (UV) resistant material, is fixed to the support 7 by means of adhesive. A thin lens 13 made of a scratchproof, compact and ultra violet (UV) resistant transparent material is mounted on the housing 1 very close to the badge 6 to avoid optical distortion. The counterweight 9 is shaped so that the centre of gravity of the entire rotating assembly is positioned between the midpoint of the two rows of bearings 4 and 5. The counterweight design ensures correct orientation. The counterweight 9 creates a centre of gravity that is radially off axis. This off axis centre of gravity provides the force to maintain the correct orientation of the visible badge. The counterweight is under hung in a manner that both avoids applying a bending movement to the bearings 4 and 5 and also loads each bearing equally. The lens 13 and end cap 8 provide a fully sealed assembly preventing ingress of debris and moisture into the rotating parts of the assembly which would adversely affect operation. The star washer 11 provides location and a small residual retention force to stop end play of the axle 8 relative to the housing 1. This is important because of the close proximity of the lens 13 to the badge 6 which in turn is necessary to reduce optical distortion. The double row bearing constrains angular movement of the badge, important because of the close proximity to the lens 13. Very slight damping is also present in the mechanism, both to avoid a long period of badge oscillation when the vehicle comes to rest and to prevent excessive oscillation due to normal road inputs occurring during driving. The damping function is friction based, the friction source being the seals on the bearings.

Referring to FIG. 3, which diagrammatically shows a cross-section through a bearing, this friction damping may be adjusted and adjustment may be achieved in different ways. The bearing comprises inner and outer races 30 and 31 between which ball bearings 34 are constrained. Grease 33 surrounds the ball bearings and seals 32 are disposed between the races 30 and 31 to prevent leakage of grease. By increasing the tightness of the seals, the friction may be increased. Alternatively, or in addition, the viscosity of the grease may be varied. The thicker the grease the higher the friction. In another alternative, the assembly may be preloaded, the higher the preload, the greater the friction. Larger diameter balls (for example 0.05 mm) create more preload if the other bearing race dimensions remain constant. High friction provides correspondingly high damping. This tends to promote rotation of the badge with the wheel at high speed, but very little oscillatory motion of the badge just after the vehicle comes to rest. Low friction provides corresponding low damping. This may mean that the badge does not rotate with the wheel at high speeds but also that there is oscillatory motion of the badge just after the vehicle comes to rest.

Although two rows of bearings have been described a single row of bearings may be used if desired. Indeed, various bearing arrangements are possible provided they offer the necessary support. Thus plain, single row (as shown in FIG. 4) or double row (as shown in FIG. 1) bearings may be used. Similarly different shapes of bearing elements may be used such as ball or roller. In FIG. 4 the bearing is referenced 40, the housing 41 and the axle mounted in the bearing 42.

Referring to FIGS. 5, 5a and 5b a modification is shown in which a centrifugal clutch is provided. As previously the badge is mounted on a support 57 which in turn is mounted through an axle 58 in a bearing 50. The possibility exists that due to forces applied during normal driving, the counterweighted axle 58 may rotate with the vehicle wheel and may continue to rotate, when the vehicle comes to rest. The clutch comprises a plate 52 connected to counterweight 53 by a spring 54. If the axle rotates centrifugal forces urges the plate out into contact with housing 51. Any tendency of the axle 58 and support 57 to continue to rotate as the vehicle wheel comes to rest is restrained by this contact The spring withdraws the plate and breaks the contact as the vehicle wheel comes to rest when the axle support and badge may return to the datum position. FIG. 5b shows the clutch in a first operative condition with the plate 52 in contact with the housing 51 and FIG. 5a shows the clutch in a second operative condition with the plate 52 not in contact with the housing 51 and the axle permitted to return to the datum position. In other respects the arrangement is as shown in FIGS. 1 and 2.

Referring to FIGS. 6, 6a and 6b, a modification is shown in which rotational speed sensitive fluid damping is provided. To this end radially extending vanes 62 are mounted on axle 68 within a sealed chamber 65 formed by sealing off part of housing 61 by means of a seal 64. The chamber 65 is partially filled with viscous fluid 69. When the vehicle is static a predetermined portion of the vanes 62 is submersed in the fluid. This is the maximum damping case. As the vehicle speed increases centrifugal force tends to distribute the fluid more evenly around the circumference of the chamber, which reduces the contact between the vanes and the fluid, reducing damping. The amount of fluid and the shape of both the chamber and the vanes can be adjusted to give the correct speed/damping relationship. Ideally the damping should be less at high speeds, to prevent significant canting over of the badge and support 67. In other respects the arrangement is the same as the previous embodiment's axle 68 being mounted in bearing 60 and a counterweight 63 being provided on the axle 68.

Referring to FIGS. 7 and 7a a modification is shown in which air damping is provided. A plurality of vanes 72 are provided, for example by moulding, on the inner surface of housing 71. A further series of vanes 73 are mounted on axle 78. All vanes extend radially and vanes of the two series are disposed in close proximity to each other. The close proximity of the housing vanes 72 and the axle vanes 73 and air viscosity create a damping effect. The form and proximity of both sets of vanes can be altered by design to achieve the required damping characteristics. The vanes could also distort due to centrifugal force, thereby altering the gap and, affecting damping. This is another tuneable element. In other respects the arrangement is the same as the previous embodiments axle 78 being mounted in bearing 70 and a counterweight 75 and support 77 being mounted on axle 78.

Referring to FIG. 8, a modification is shown is which magnetic damping is provided. For this purpose a magnet 82 is mounted on a non-rotating part of the vehicle and a magnetic plate 83 on support 87. The magnetic attraction between magnet 82 and plate 83 provides the required damping and controls the orientation of the support 87 and badge supported on it. In other respects the arrangement is the same as previous embodiments axle 88 being mounted in bearing 80.

It would also be possible to control the position of the badge electronically by means of a feedback arrangement in which deviation from a desired datum position is used to produce a signal which is fed back and used to return the badge to the datum position. A stepper motor or other appropriate means could be used to index the badge.

The above described arrangements are designed to be maintenance free. All parts are physically and dimensionally stable for the operating conditions encountered so that the assembly remains functional over the life of the vehicle. Each assembly can also be retro fitted to existing vehicle wheel designs without modification of those designs.

It will be appreciated that the above embodiments has been described, by way of example only and that many variations are possible without departing from the invention.

1. Apparatus for maintaining the orientation of a badge or other insignia on a rotatable member comprising a housing adapted for attachment to the rotatable member, bearing means located within the housing, a support mounted in the bearing means and adapted to carry the badge or other insignia and means for urging the support to a datum position with respect to the housing whereby, in operation, the orientation of the support and any badge or other insignia connected to it may be maintained, relative to the housing, as the housing rotates.

2. Apparatus as claimed in claim 1, in which the housing is moulded from synthetic plastics material.

3. Apparatus as claimed in claim 1, in which the housing is adapted to be a snap fit in the rotatable member in which it is, in use, to be connected.

4. Apparatus as claimed in claim 3, in which tabs are provided on the housing to enable the snap fit.

5. Apparatus as claimed in claim 1, in which the bearing means comprises two bearings.

6. Apparatus as claimed in claim 5, in which the support comprises an axle and the two bearings are axially spaced along the axle.

7. Apparatus as claimed in claim 6, in which the bearings are retained on the axle by means of a retainer.

8. Apparatus as claimed in claim 7, in which the retainer comprises a star washer.

9. Apparatus as claimed in claim 8, in which the star washer is made of spring steel.

10. Apparatus as claimed in claim 1, in which the badge or other insignia are connected to the support.

11. Apparatus as claimed in claim 10, in which the badge or other insignia are connected to the support by means of adhesive.

12. Apparatus as claimed in claim 1, in which the means for urging the support comprises a counterweight.

13. Apparatus as claimed in claim 12, in which the counterweight forms an integral part of the support.

14. Apparatus as claimed in claim 12, in which the counterweight provides a centre of gravity which is radially off axis and is hung in a manner which both avoids applying a bending movement to the bearings and also loads each of the two bearings equally.

15. Apparatus as claimed in claim 1, in which a lens is positioned closely adjacent to the badge or other insignia.

16. Apparatus as claimed in claim 15, in which the lens is sealed in a housing.

17. Apparatus as claimed in claim 15, in which an end cap closes off the housing on the side remote from the lens.

18. Apparatus as claimed in claim 17, in which the lens and end cap together form a sealed assembly.

19. Apparatus as claimed in claim 1, in which damping means are provided to resist oscillation of the badge or other insignia.

20. Apparatus as claimed in claim 19, in which the damping is friction based.

21. Apparatus as claimed in claim 20, in which the friction is provided by seals or the bearing means.

22. Apparatus as claimed in claim 21, in which the friction damping is adjustable.

23. Apparatus as claimed in claim 19, in which the dampings means comprises a centrifugal clutch.

24. Apparatus as claimed in claim 19, in which the damping means comprises speed sensitive fluid damping.

25. Apparatus as claimed in claim 19, in which the damping means is magnetic.

26. Apparatus as claimed in claim 19, in which the damping means is air damping.

27. Apparatus as claimed in claim 1, in which the means for urging the support to a datum position are electronic means.

28. Apparatus as claimed in claim 27, in which the electronic means comprises a stepper motor operative to respond to a feedback signal to return the badge or other insignia to the datum position.

29. A vehicle wheel comprising apparatus as claimed in claim 1.
